(19) United States
(12) Patent Application Publication
(10) Pub. No.: US 2004/0169400 A1
(43) Pub. Date: Sep. 2, 2004

(54) Vehicle body panel and method of manufacturing same

(76) Inventors: Hans Joachim Langhoff, Gifhorn (DE); Matthias Ludwig, Vechelde (DE); Marcus Lutz, Gifhorn (DE); Tobias Niesner, Wolfsburg (DE); Harald Batke, Gerstenbuttel (DE); Frank Niebuhr, Wilsche (DE)

Correspondence Address: CARLSON, GASKEY & OLDS, P.C., 400 WEST MAPLE ROAD, SUITE 350, BIRMINGHAM, MI, 48009, US

(21) Appl. No.: 10/784,054

(22) Filed: Feb. 20, 2004

(30) Foreign Application Priority Data
Feb. 27, 2003 (DE) 103 08 582.3

(51) Int. Cl. B62D 25/00

(52) U.S. Cl. 296/191

(57) ABSTRACT

A vehicle body panel and a method for manufacturing a vehicle body panel includes a thin plastic film that is applied to a deep-drawn, film-like exterior covering before a back-foamed layer is applied to the exterior covering. When the film hardens, it improves the structural stability of the film, preventing indentations due to varying levels of shrinkage of the back-foamed layer from becoming visible on the exterior covering.

### REFERENCE TO RELATED APPLICATIONS

The present invention claims the benefit of German Patent Application No. 103 08 582.3, filed Feb. 27, 2003.

### TECHNICAL FIELD

The present invention relates to a vehicle body part and a method for manufacturing a vehicle body panel.

### BACKGROUND OF THE INVENTION

Vehicle body panels are increasingly being manufactured by vehicle suppliers and are mounted on the body frame by the vehicle manufacturer. Panels can be used on any large portion of the vehicle body as well as in smaller components, such as bumpers and fenders. Vehicle body panels are often manufactured as a sandwiched structure because of their lightness and stability. These sandwiched structures usually have a thin, film-like deep-drawn exterior covering made of plastic or aluminum. The visible side of the exterior covering in its installed state must meet high standards with respect to its surface quality. The goal is to achieve a so-called “class-A” surface, which is extremely smooth.

However, this “class-A” surface quality is difficult to achieve for various reasons. First, the film-like exterior covering is usually foam-backed, with the foam forming a lightweight support layer. The foam support layer, however, is formed to contain a plurality of webs or, in general terms, agglomerations of mass. Foam shrinks when it hardens, causing greater shrinkage in areas having greater thickness and less shrinkage in areas having less thickness. This uneven shrinkage creates or “valleys” in the film-like exterior covering because the exterior covering is very thin, has low structural stability of its own, and therefore conforms to the shape of the foam. These indentations are visible from outside and can degrade the visual quality of the surface.

Another problem can arise if fibers, usually glass fibers, are embedded in the foam. Fiber embedment normally occurs during the application of the liquid plastic, before the foaming process via a LFI (Long-Fiber-Injection) method. After the hardening, the fibers can leave imprints on the exterior surface of the covering if they are disposed directly on the reverse side of the covering and if, in addition, the cut edge of the fibers are oriented perpendicular to the exterior covering. This imprinting occurs when the fibers press against the underside of the exterior covering, creating small, elevated locations on the visible side of the covering and degrading surface quality.

There is a desire for a manufacturing process that avoids the surface quality problems inherent in existing processes.

### SUMMARY OF THE INVENTION

The present invention is directed to a simple method of manufacturing a vehicle body panel that offers excellent exterior surface quality in a very cost-effective manner.

This is achieved as a result of the following sequence of steps:

a) a thin film of liquid, hardening plastic is applied directly on the reverse side of a deep-drawn, film-like exterior covering,

b) the plastic material is hardened without foaming, and

c) the exterior covering, with the plastic material on the reverse side, is foam-backed on the reverse side.

The liquid plastic material becomes a hard, thin film that stabilizes the exterior covering and prevents indentations caused by the varying thicknesses of the back-foamed layer from occurring and from becoming visible on the thin exterior covering. The hard film also prevents fibers from imprinting themselves on the exterior side of the exterior covering after the foam-backing process.

A further advantage lies in the fact that the film-like exterior covering no longer needs to be seared on the reverse side, as is necessary in the related art, to make the exterior covering “reactive” for the later applications of polyurethane foam and to achieve a bond between the exterior covering and the back-foamed layer. Searing of this type can be completely dispensed within the inventive method.

Yet another advantage lies in the fact that it is possible to achieve a back-foamed layer that is generated by the foam-backing process and that has markedly varying thicknesses in a single working operation. Normally, creating a back-foamed layer having varying thicknesses requires producing a first foam layer of uniform thickness, which stabilizes the intermediate product made by the exterior covering and the foam layer, then adding another foam layer having segments of markedly varying thicknesses on the stabilized intermediate product. The stabilized intermediate product prevents indentations from forming on the exterior covering, but this method requires the use of two different foam dies, one for producing the first foam layer and another for producing the second foam layer. The inventive method, however, makes it possible to use only one die to manufacture a vehicle body part that has a back-foamed layer having segments of markedly different thicknesses.

### BRIEF DESCRIPTION OF THE DRAWINGS

Further features and advantages of the present invention will become apparent from the following description and from the following drawings, to which reference is made. In the drawings:

FIG. 1 depicts a vehicle body part manufactured using the method according to the present invention in the form of a vehicle roof module,

FIG. 2 depicts a partial cutaway section of the vehicle roof module in FIG. 1;

FIGS. 3 through 5 depict sequential steps in the manufacturing method of the vehicle body part according to one embodiment of the present invention.

### DETAILED DESCRIPTION OF THE EMBODIMENTS

The invention is generally directed to a method of manufacturing a vehicle body by applying a thin film of liquid, hardening plastic is applied directly on the reverse side of a deep-drawn, film-like exterior covering, hardening the plastic without applying any foam material, and then applying a foam backing on the plastic material.

The liquid plastic material, which, for example, can be polyester resin or polyurethane, becomes a rigid film after hardening, stabilizing the exterior covering and preventing indentations caused by the varying thicknesses of the back-foamed layers from occurring and from becoming visible on the exterior covering, thereby maintaining a high surface quality on the visible surface of the exterior covering. The rigid film also prevents fibers from imprinting themselves on the exterior side of the exterior covering after the foam-backing process.

The exterior covering may be made from a thin plastic or aluminum deep-drawn sheet that is roughly 0.5 to 1.5 mm thick. The film can be sprayed on the reverse side of the exterior covering, outside of a foam die or, depending on the hardening time, within the foam die, where it is subsequently backed with foam.

The film may be made of a thermosetting plastic material, such as polyester resin or polyurethane. The film is applied not as foam but rather as a thin, very dense, and hard film that reinforces the exterior covering.

During the foam-backing process, the liquid plastic to be foamed, which is usually polyurethane material, can be applied directly onto the hardened film. An optional fiberglass mat can be placed onto the exterior covering and the film after the film has hardened and before the foam backing is applied. Once the exterior covering is backed with foam, the foam material penetrates the fiberglass matt and binds itself to the rigid film.

With the method according to the present invention, it is also easy to embed inserts in the body part using the foam. Possible inserts may include, for example, hollow bodies that form the interior of webs, tubes, or attachment parts that partially protrude from the foam and allow the body part to be secured to the vehicle. It is also conceivable to attach sun visors, grab handles, or other component parts to these attachment parts. These inserts may be inserted into the foam die before the foam-backing process. They are subsequently embedded in the foam after the foamed layer hardens to form a component of the body part.

As mentioned above, the method according to the present invention allows a single back-foamed layer to be created during the foam backing process even in structures where the back-foamed layer has a varying thickness.

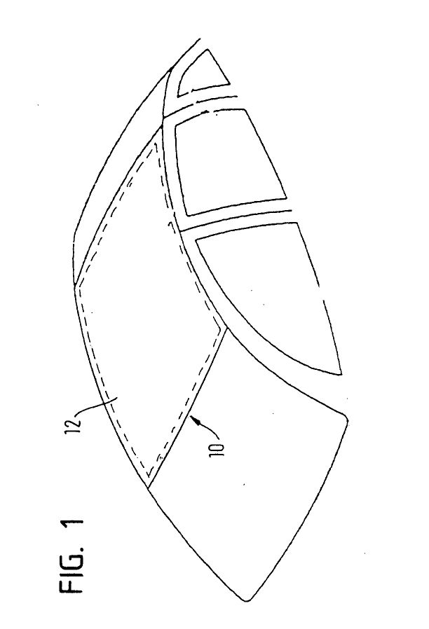

Referring now to the figures, FIG. 1 illustrates a vehicle whose roof is supplied as a separately manufactured vehicle body part in the form of a roof module and is attached to the body frame. The vehicle roof module 10 has an exterior covering 12 having a class-A exterior surface.

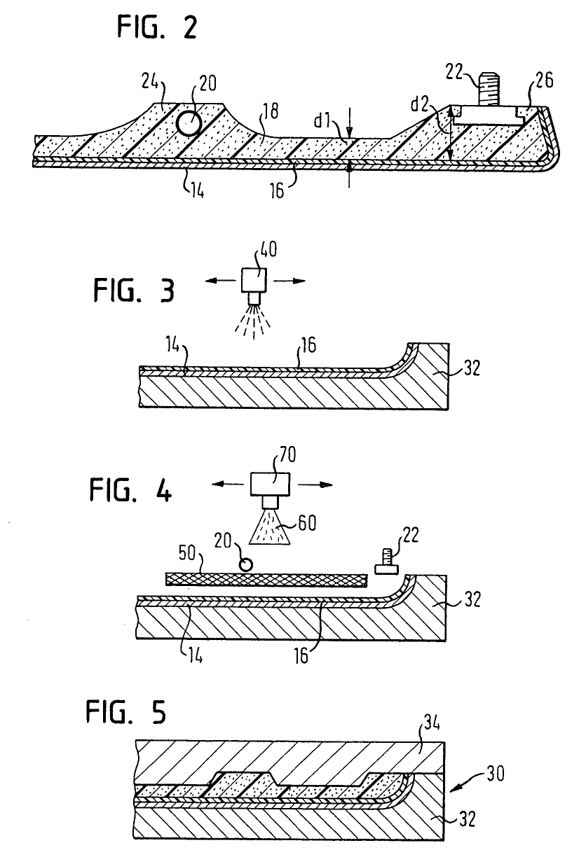

FIG. 2 shows that the vehicle roof module has a sandwich-like design. An exterior covering 14 is visible from the outside in the installed state and is made up of a painted plastic or aluminum film, which may be shaped by a deep drawing process. In one embodiment, the thickness of the sheet-like exterior covering is between 0.5 and just under 1.5 mm. A film 16 is applied directly on the exterior covering 14. In one embodiment, the film 16 is bonded to the exterior covering 14 and has a maximum thickness of roughly 0.8 mm and is made of relatively hard, non-foamed plastic, such as polyester resin or polyurethane.

A back-foamed layer 18 is applied to the reverse side of the film 16. The back-foamed layer 18 may be made of polyurethane material. The back-foamed layer 18 is the only layer of the vehicle roof module that is generated using a foam-backing process. In one embodiment, the back-foamed layer 18 has segments of varying thicknesses, the thinnest segment having a thickness d1 that is less than half as thick as the thickest segment having thickness d2.

Various inserts 20, 22 may be embedded in the back-foamed layer 18. In the illustrated example, the inserts include a hose-like hollow body 20 along a raised section 24, and attachment elements having threaded bolts protruding from back-foamed layer 18 along an edge section 26. Of course, other inserts may be incorporated without departing from the scope of the invention.

The manufacturing method for vehicle roof module 10 will now be explained with reference to FIGS. 3 through 5.

In one embodiment, the exterior covering 14 is permanently shaped through deep drawing or in a lower mold half 32 of a foam die 30 having the lower mold half 32 and an upper mold half 34 (see FIGS. 3 through 5). The exterior covering, as noted above, may be made of plastic or aluminum. Plastic exterior coverings advantageously have color distributed throughout the film, thus making exterior enameling unnecessary. Aluminum exterior coverings have their main structures made of aluminum but are also furnished with a very thin, through-painted plastic layer.

A path-controlled spray head 40 sprays and applies a liquid plastic on the reverse side of the exterior covering 14 to form a thin, rigid plastic film 16. The plastic film 16 completely covers the reverse side of exterior covering 14. The film 16 may be made of polyester resin or polyurethane material. After hardening, which occurs without foaming, the rigid film 16 has a hardness that significantly exceeds the hardness and the density of back-foamed layer 18 that will be applied later in the process.

This application of the thin, subsequently hardened plastic film can be accomplished in a foam die, as depicted in FIG. 3, but it can also be carried out outside of the foam die. Note that the reverse side of the exterior covering 14 no longer requires searing because the covering 14 is sprayed without any prior treatment, as shown in FIG. 3.

Next, an optional fiberglass mat 50 is applied directly onto the film 16. In addition, optional inserts 20, 22, if used, may be positioned in the die. The steps of inserting the fiberglass mat 50 and inserts 20, 22, are optional and may be omitted without departing from the scope of the invention.

After the exterior covering 14 is inserted into the lower part 32 of the die 30 and is provided with the film 16 on its reverse side, a liquid polyurethane material 60 or other material may be subsequently applied using a remote-controlled nozzle tip 70. The material 60 may be any foamable material. During application, glass fibers may be added to the liquid polyurethane material 60, which mix uniformly with the material 60 when the material is foamed (FIG. 4). Alternatively or in addition, the glass fibers may be added to the material 60 by, for example, a long fiber injection (LFI) method.

After the complete application of liquid polyurethane material 60, the die 30 is closed by attaching the upper mold half 34 to the lower mold half 32. The die 30 is then heated to foam the polyurethane material 60 and create the back-foamed layer 18 (FIG. 5). Note that the optional inserts 20, 22 are omitted from FIG. 5 for clarity. As can be seen in FIG. 5, the foamed layer conforms to the varied profile of the upper mold half 34 to form a foamed layer having a varying thickness. Forming a varied thickness foamed layer in this manner allows a single foamed layer to vary in thickness by at least a factor of two, if desired, without resorting to forming multiple foamed layers.

As a result, the inventive method forms a vehicle roof module having high surface quality. The thin, rigid film applied to the back side of the exterior covering between the exterior covering and the foam backing improves the structural stability of the covering during manufacture. This prevents the covering from indenting, buckling, or otherwise degrading its surface quality due to characteristics of the foam backing and any fibers embedded in the foam backing.

It should be understood that various alternatives to the embodiments of the invention described herein may be employed in practicing the invention. It is intended that the following claims define the scope of the invention and that the method and apparatus within the scope of these claims and their equivalents be covered thereby.

What is claimed is:

1. A method for manufacturing a vehicle body panel, comprising:
applying a plastic film onto a reverse side of a film-like exterior covering;
hardening the plastic film; and
applying a back-foamed layer on top of the hardened plastic film.

2. The method of claim 1, wherein the film is applied by a spraying process.

3. The method as recited in claim 1, wherein the step of applying the back-foamed layer comprises:
applying liquid plastic onto the plastic film after the hardening step; and
foaming the liquid plastic to form the back-foamed layer on the plastic film.

4. The method as recited in claim 1, further comprising adding fibers to the back-foamed layer.

5. The method as recited in claim 4, wherein the fibers are added by a long fiber injection method.

6. The method as recited in claim 4, wherein the fibers are added by placing a fiber mat onto the hardened plastic film before the step of applying the back-foamed layer.

7. The method as recited in claim 4, wherein the fibers are added by being mixed with a material used to form the back-foamed layer.

8. The method as recited in claim 1, wherein the exterior covering is disposed in an open foam die, and wherein the steps of applying the plastic film, hardening the plastic film, and applying the back-foamed layer are conducted in the open foam die.

9. The method as recited in claim 8, further comprising placing at least one insert into the open foam die before the step of applying the back-foamed layer, wherein said at least one insert is embedded into the back-foamed layer after the step of applying the back-foamed layer.

10. The method as recited in claim 8, wherein the open foam die comprises an upper mold half and a lower mold half, and wherein the step of applying the back-foamed layer comprises molding the back-foamed layer against the upper mold half to form varying thicknesses in the back-foamed layer.

11. A vehicle body panel, comprising:
a film-like exterior covering;
a rigid film disposed on a reverse side of the exterior covering; and
a back-foamed layer on top of the rigid film.

12. The vehicle body panel as recited in claim 11, wherein the back-foamed layer is a hardened back-foamed layer, and wherein the hardness of the hardened plastic film is greater than that of the hardened back-foamed layer.

13. The vehicle body panel as recited in claim 11, further comprising fibers disposed in the back-foamed layer.

14. The vehicle body panel as recited in claim 13, wherein the fibers are formed in a fiber mat.

15. The vehicle body panel as recited in claim 13, wherein the fibers are dispersed throughout the back-foamed layer.

16. The vehicle body panel as recited in claim 11, further comprising at least one insert embedded into the back-foamed layer.

17. The vehicle body panel as recited in claim 11, wherein the foamed layer is a single back-foamed layer having varying thicknesses.

18. The vehicle body panel as recited in claim 17, wherein the varying thicknesses in the back-foamed layer differ by at least a factor of two.

19. The vehicle body panel as recited in claim 11, wherein the exterior covering is a sheet made of material selected from the group consisting of aluminum and plastic.

20. The vehicle body panel as recited in claim 11, wherein the rigid film is made of a thermosetting material.

21. The vehicle body panel as recited in claim 20, wherein the thermosetting material is one selected from the group consisting of polyester resin and polyurethane.
